(19) United States
(12) Patent Application Publication
(10) Pub. No.: US 2023/0349942 A1
(43) Pub. Date: Nov. 2, 2023

(54) DISPENSING DEVICE AND DETACHMENT PLATE

(71) Applicant: SHIMADZU CORPORATION, Kyoto (JP)

(72) Inventor: Hiroyuki YAMASHITA, Kyoto (JP)

(73) Assignee: SHIMADZU CORPORATION, Kyoto (JP)

(21) Appl. No.: 18/135,158

(22) Filed: Apr. 16, 2023

(30) Foreign Application Priority Data
Apr. 28, 2022 (JP) 2022-075328

(51) Int. Cl. G01N 35/10; B01L 3/02

(52) U.S. Cl. CPC G01N 35/1074; B01L 3/0286; G01N 2035/103; B01L 2300/0832; B01L 2300/0829

(57) ABSTRACT

A plurality of syringes are aligned in a first direction that intersects with a vertical direction while being directed downwardly. A detachment frame has a plate shape in which a through hole into which the plurality of syringes are inserted and is provided to be liftable and lowerable relative to the plurality of syringes. The detachment frame has a first region located at a position lower than a predetermined height threshold value defined with respect to the detachment frame and a second region located at a position higher than the height threshold value in a lower surface, and the first region and second region are arranged alternately in the first direction. In a tip attachment region, a tip is attached to the lower end portion of each of the plurality of syringes that project farther downwardly than the detachment frame through the through hole.

### BACKGROUND

### Technical Field

The present invention relates to a dispensing device and a detachment plate.

### Description of Related Art

A dispensing device has been known as a device that sucks a sample from a predetermined plate and discharges the sample to another plate. For example, JP 4927719 B2 discloses a high-speed automatic dispensing device having a dispensing head. The dispensing head includes a plurality of pipettes and a detachment plate. A disposable tip is attached to the tip of each pipette.

With each tip being inserted so as to be immersed in liquid provided in a mother plate, the liquid is sucked into the tip. Next, each tip is inserted into a test tube of a dispense plate, and a liquid material in the tip is discharged to the test tube. Thereafter, the tip detachment plate is lowered above a tip disposal position to detach the tip from each pipette.

### SUMMARY

The dispensing device is capable of dispensing a sample to the number of dispensing positions that is larger than the number of pipettes. For example, JP 4927719 B2 describes dispensing of a sample into 384 test tubes arranged in 16 rows and 24 columns in a dispense plate with use of 96 pipettes arranged in 8 rows and 12 columns. However, it is not possible to dispense a sample to the number of test tubes that is smaller than the number of pipettes by using a plurality of pipettes. Therefore, the usability of the dispensing device is degraded.

Further, when the number of tips connected to the dispensing device is large, a large force is required to detach the tips. Therefore, a mechanism for increasing a torque is required. Further, in a case in which a torque is insufficient, the tips cannot be removed.

An object of the present invention is to provide a dispensing device and a detachment frame capable of improving usability and reliably detaching a tip.

One aspect of the present invention relates to a dispensing device that includes a plurality of syringes being aligned in a first direction that intersects with a vertical direction while being directed downwardly, a detachment frame that has a plate shape having a through hole into which the plurality of syringes are inserted and is provided to be liftable and lowerable relative to the plurality of syringes, and a tip attachment region in which a tip is attachable to a lower end portion of each of the plurality of syringes that project farther downwardly than the detachment frame through a through hole, wherein the detachment frame has a first region located at a position lower than a predetermined height threshold value defined with respect to the detachment frame and a second region located at a position higher than the height threshold value in a lower surface, and the first region and the second region are arranged alternately in the first direction.

Another aspect of the present invention relates to a detachment frame that is used in a dispensing device including a plurality of syringes that are aligned in a first direction intersecting with a vertical direction while being directed downwardly, wherein a detachment frame has a plate shape having a through hole into which the plurality of syringes are inserted, and a tip attachment region in which a tip is attachable to a lower end portion of each of the plurality of syringes that project farther downwardly than the detachment frame through the through hole, and the detachment frame has a first region located at a position lower than a predetermined height threshold value defined with respect to the detachment frame and a second region located at a position higher than the height threshold value in a lower surface, and the first region and the second region are arranged alternately in the first direction.

With the present invention, it is possible to improve usability of a dispensing device and reliably detach a tip.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a perspective view showing the appearance of a dispensing device according to one embodiment of the present invention;

FIG. 2 is a side view showing the dispensing device of FIG. 1;

FIG. 3 is a plan view showing the configuration of a detachment frame of FIG. 1;

FIG. 4 is a perspective view of the detachment frame of FIG. 3;

FIG. 5 is a side view of the detachment frame of FIG. 3;

FIG. 6 is a partially enlarged diagram of the detachment frame of FIG. 5;

FIG. 7 is a diagram for explaining an operation of detaching a tip with use of the detachment frame;

FIG. 8 is a diagram for explaining an operation of detaching a tip with use of the detachment frame;

FIG. 9 is a diagram for explaining an operation of detaching a tip with use of the detachment frame;

FIG. 10 is a plan view showing the configuration of a detachment frame according to a first modified example; and

FIG. 11 is a partially enlarged view of a detachment frame according to a second modified example.

### DETAILED DESCRIPTION

### (1) Dispensing Device

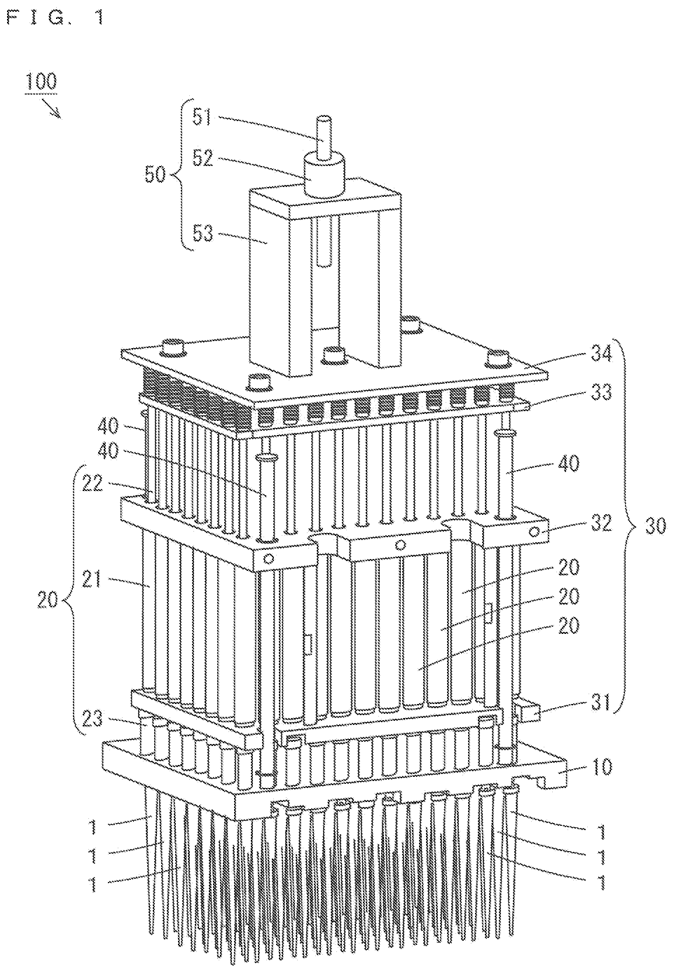

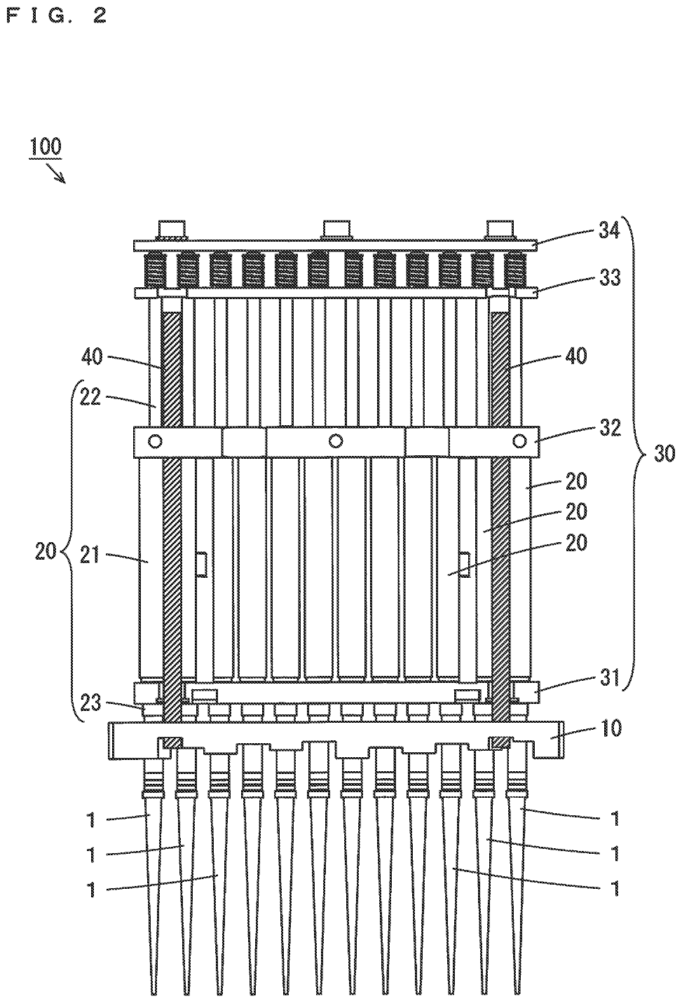

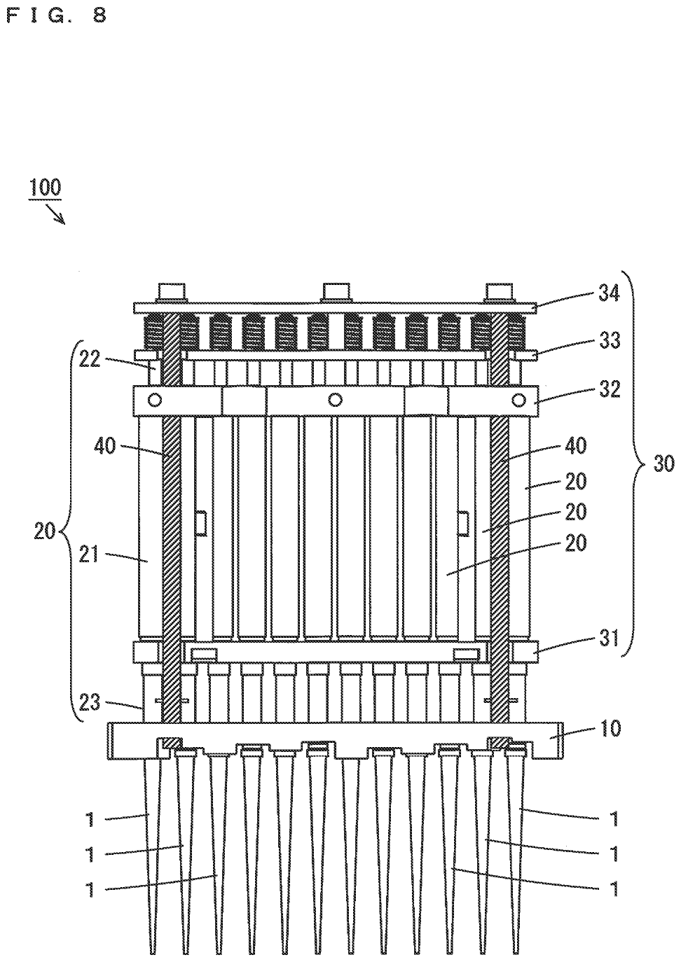

A dispensing device and a detachment plate according to embodiments of the present invention will be described below in detail with reference to the drawings. FIG. 1 is a perspective view showing the appearance of a dispensing device according to one embodiment of the present invention. FIG. 2 is a side view showing the dispensing device 100 of FIG. 1. As shown in FIGS. 1 and 2, the dispensing device 100 includes a detachment frame 10, a plurality of syringes 20, a holder 30, a plurality (four in the present example) of rods 40 and a driver 50. In FIG. 2, the driver 50 is not shown. Further, in FIG. 2, a hatching pattern is applied to the plurality of rods 40 in order to facilitate visual recognition. The same also applies to FIG. 8, described below.

In the present example, 96 syringes 20 are aligned in 8 rows and 12 columns while being directed downwardly. Each syringe 20 includes a barrel 21, a plunger 22 and a nozzle 23. The barrel 21 has a cylindrical shape. A piston (not shown) is provided in the barrel 21. The plunger 22 has a bar shape and is inserted into the barrel 21 from an upper portion of the barrel 21. The lower end portion of the plunger 22 is connected to a piston. The nozzle 23 has a cylindrical shape and is attached to the lower portion of the barrel 21.

The holder 30 includes fixed plates 31, 32 and mobile plates 33, 34. The fixed plates 31, 32 are fixed to a base (not shown) so as to be arranged in a vertical direction, and hold the lower portion and the upper portion of the barrel 21 of each syringe 20. The mobile plates 33, 34 liftably and lowerably hold the plunger 22 of each syringe 20. The mobile plate 34 is arranged above the mobile plate 33.

The detachment frame 10 has a rectangular plate shape. A plurality of through holes are formed in the detachment frame 10. Details of the detachment frame 10 will be described below. Below the fixed plate 31, the detachment frame 10 is connected to the fixed plate 31 while being biased upwardly by a plurality of spring members (not shown). The nozzle 23 of each syringe 20 is inserted into a through hole of the detachment frame 10. A tip attachment region is provided below the detachment frame 10. In the tip attachment region, a disposable tip 1 is attached to the lower end portion of each nozzle 23 projecting downwardly from the detachment frame 10.

The four rods 40 extend respectively and upwardly from the positions in the vicinity of the four corners of the detachment frame 10, and penetrate the fixed plates 31, 32 and the mobile plate 33. The upper end portion of each rod 40 projects farther upwardly than the mobile plate 33. In a normal state, the upper end portion of each rod 40 and the lower surface of the mobile plate 34 are spaced apart from each other by a predetermined distance.

The driver 50 includes an actuator 51, a mover 52 and a coupling arm 53. The actuator 51 is a stepping motor, for example, and has a rotation shaft. In FIG. 1, only the rotation shaft of the actuator 51 is shown. The actuator 51 is fixed to a base (not shown) with the rotation shaft extending downwardly. The mover 52 includes a linear-motion ball screw portion and is attached to the rotation shaft of the actuator 51. The coupling arm 53 couples the mover 52 and the upper surface of the mobile plate 34 to each other.

When the rotation shaft of the actuator 51 rotates, the mover 52 moves in the vertical direction along the rotation shaft. In this case, the plunger 22 of each syringe 20 moves in the vertical direction via the coupling arm 53 and the mobile plate 34. Thus, a piston slides in the vertical direction in each barrel 21. When the piston slides upwardly, a sample is sucked into the corresponding tip 1. When the piston slides downwardly, a sample that has been sucked into the corresponding tip 1 is discharged.

### (2) Detachment Frame

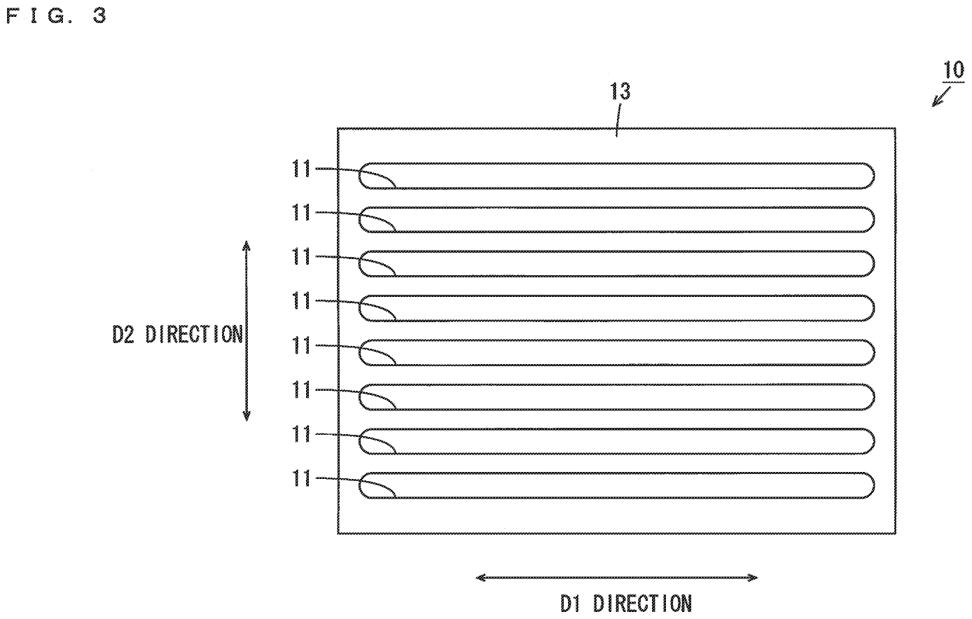

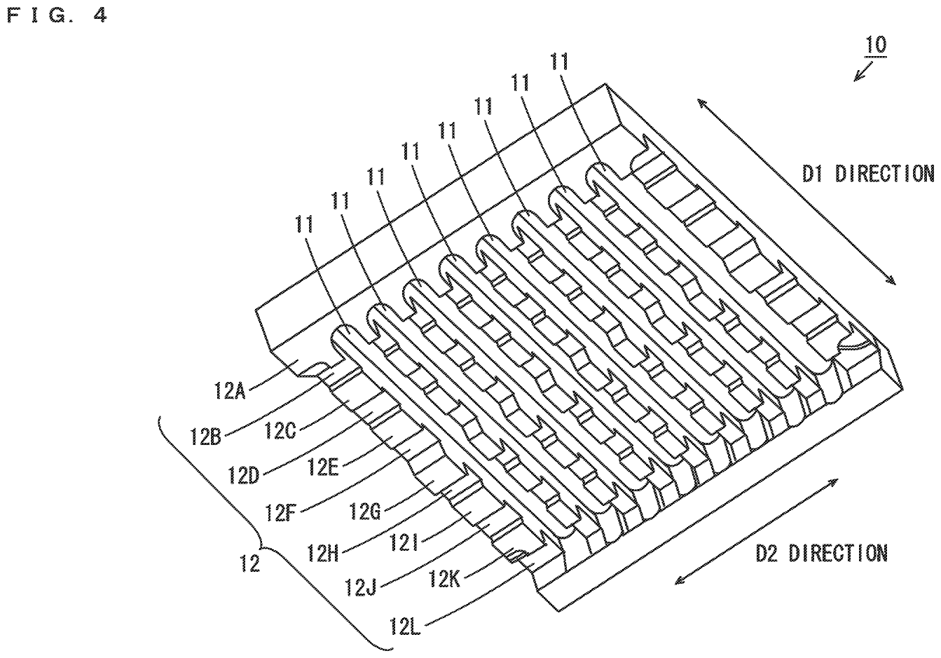

FIG. 3 is a plan view showing the configuration of the detachment frame 10 of FIG. 1. FIG. 4 is a perspective view of the detachment frame 10 of FIG. 3. As shown in FIGS. 3 and 4, the detachment frame 10 has a rectangular plate shape. In a plan view, the direction in which a pair of sides of the detachment frame 10 extends is referred to as a D1 direction, and the direction in which the other pair of sides of the detachment frame 10 extends is referred to as a D2 direction.

In the detachment frame 10, a plurality (eight in the present example) of through holes 11 extending in the D1 direction are formed. The plurality of through holes 11 are aligned at equal intervals in the D2 direction. The width of each through hole 11 in the D2 direction is larger than the outer diameter of the nozzle 23 of FIG. 1 and smaller than the outer diameter of the tip 1. The nozzles 23 of the plurality (twelve in the example of FIG. 1) of syringes 20 arranged in the D1 direction are inserted into the respective through holes 11 from above.

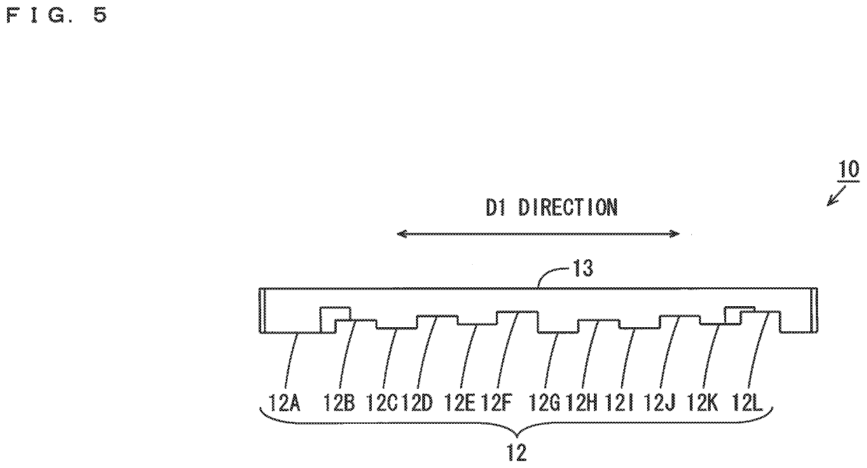

FIG. 5 is a side view of the detachment frame 10 of FIG. 3. As shown in FIG. 5, a lower surface 12 of the detachment frame 10 is sectioned into a plurality (twelve in the present example) of regions 12A to 12L arranged in this order in the D1 direction. The plurality of regions 12A to 12L respectively correspond to the plurality of syringes 20 arranged in the D1 direction. The regions 12A, 12C, 12E, 12G, 12I, 12K are located at positions lower than a predetermined height threshold value defined for the detachment frame 10. On the other hand, the regions 12B, 12D, 12F, 12H, 12J, 12L are located at positions higher than the height threshold value.

In this manner, in the lower surface 12 of the detachment frame 10, the regions 12A, 12C, 12E, 12G, 12I, 12K located at positions lower than the height threshold value and the regions 12B, 12D, 12F, 12H, 12J, 12L located at positions higher than the height threshold value are alternately arranged in the D1 direction. In the present example, the height positions of the regions 12A to 12F are different from one another, and the height positions of the regions 12G to 12L are different from one another. Further, the height positions of the regions 12G to 12L are equal to the height positions of the regions 12A to 12F, respectively. The height positions of the regions 12A to 12F will be described below.

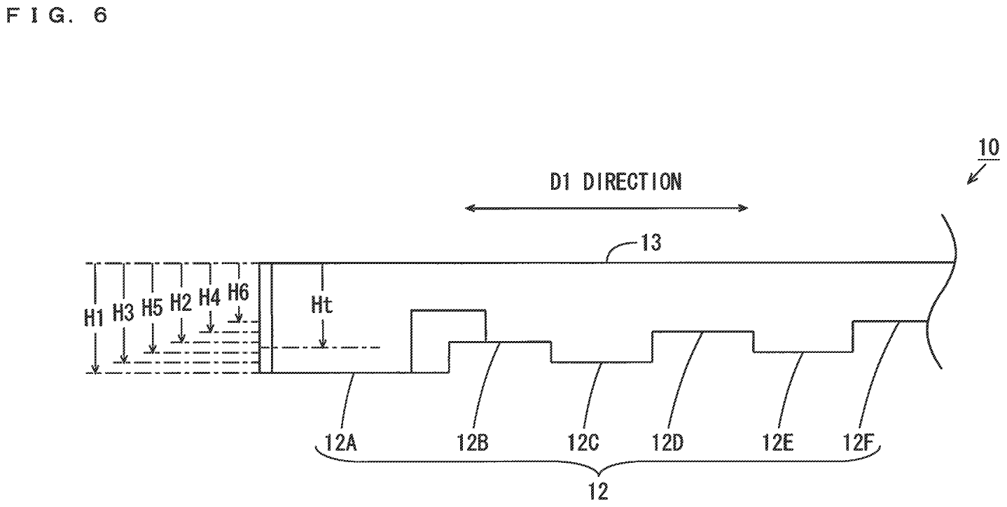

FIG. 6 is a partially enlarged diagram of the detachment frame 10 of FIG. 5. As shown in FIG. 6, the regions 12A to 12F are respectively located at height positions H1 to H6 with respect to a predetermined reference position (the upper surface 13 of the detachment frame 10 in the present example) defined for the detachment frame 10. Here, the height positions H6, H4, H2, H5, H3, H1 are located in this order in the downward direction. A height threshold value Ht is defined between the height position H2 and the height position H5. The reference position is not limited to the upper surface 13 of the detachment frame 10. Further, the shape of the upper surface 13 of the detachment frame 10 is not limited to a flat surface.

### (3) Operation of Detaching Tip

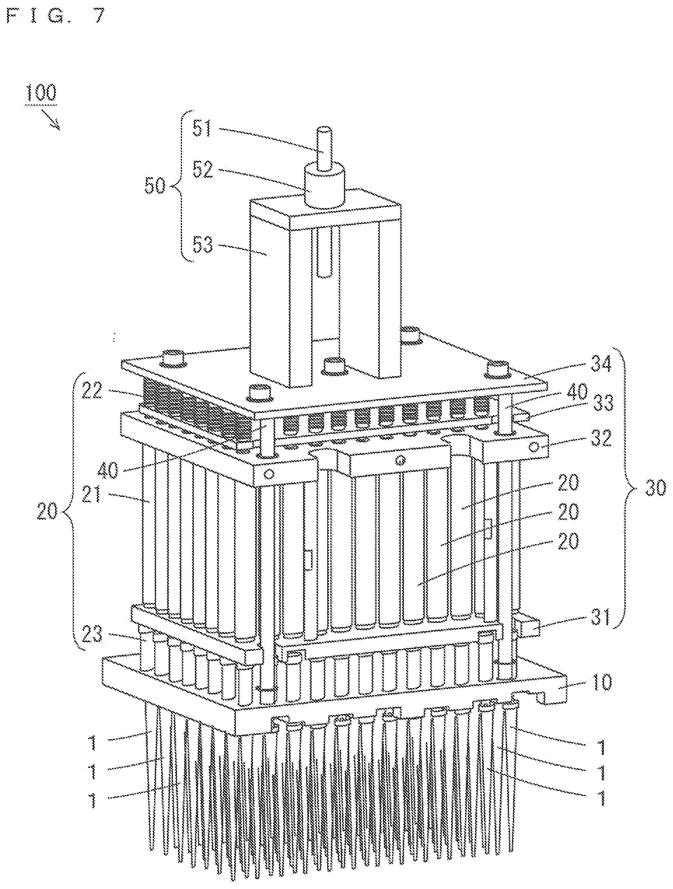

FIGS. 7 to 9 are diagrams for explaining an operation of detaching a tip 1 with use of the detachment frame 10. As shown in FIGS. 1 and 2, the rotating shaft of the actuator 51 is rotated in a range in which the upper end portion of each rod 40 and the lower surface of the mobile plate 34 are spaced apart from each other, whereby an operation of sucking a sample or an operation of discharging a sample is performed.

As shown in FIGS. 7 and 8, when the rotation shaft of the actuator 51 is rotated in one direction by an angle equal to or larger than a constant angle, the mobile plate 34 is relatively largely downwardly moved, and the upper end portion of each rod 40 and the lower surface of the mobile plate 34 come into contact with each other. In this state, when the rotation shaft of the actuator 51 is further rotated in the one direction, the detachment frame 10 is moved downwardly with respect to the plurality of syringes 20 together with each rod 40.

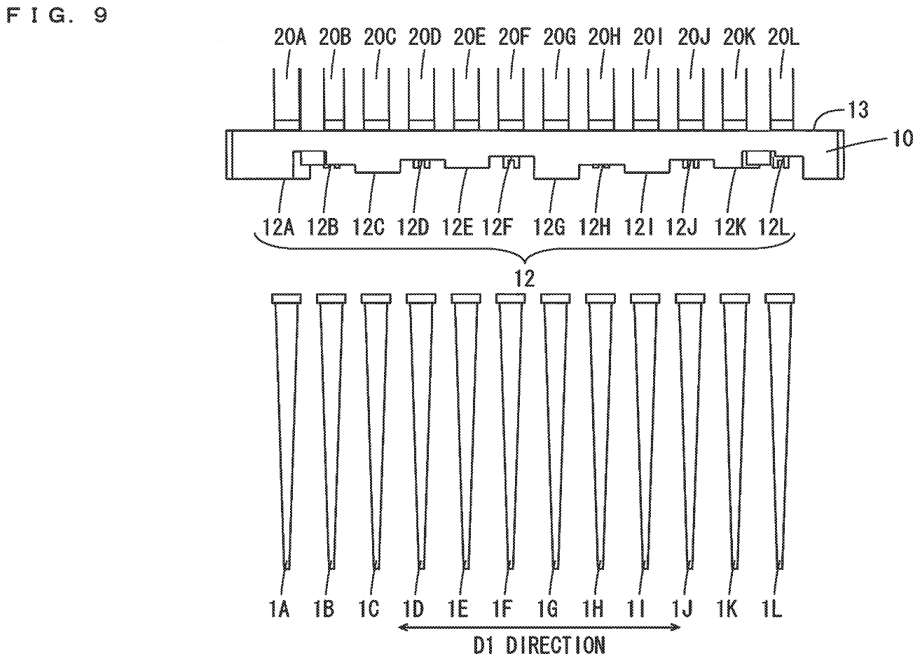

Here, as shown in FIG. 9, the plurality of syringes 20 arranged in order in the D1 direction are referred to as syringes 20A to 20L, respectively. Further, a plurality of tips 1 respectively attached to the nozzles 23 of the syringes 20A to 20L are referred to as tips 1A to 1L. When the detachment frame 10 is moved downwardly, the regions 12A, 12G of the lower surface 12 of the detachment frame 10 that are located at the lowest positions first come into contact with the upper end surfaces of the tips 1A, 1G. In this state, the detachment frame 10 is moved farther downwardly, thereby detaching the respective tips 1A, 1B from the respective syringes 20A, 20G.

When the detachment frame 10 is moved farther downwardly, the regions 12C, 12I of the lower surface 12 of the detachment frame 10 that are located at the second lowest positions come into contact with the upper end surfaces of the tips 1C, 1I next. In this state, when the detachment frame 10 is moved farther downwardly, the tips 1C, 1I are detached from the syringes 20C, 20I, respectively. Similarly, when the detachment frame 10 is further moved downwardly, the tips 1E, 1K are detached from the syringes 20E, 20K, respectively.

Further, when the detachment frame 10 is moved farther downwardly, the tips 1B, 1H are detached from the syringes 20B, 20H, respectively. When the detachment frame 10 is moved farther downwardly, the tips 1D, 1J are detached from the syringes 20D, 20J, respectively. When the detachment frame 10 is moved farther downwardly, the tips 1F, 1L are detached from the syringes 20F, 20L, respectively.

Therefore, after the use of the tips 1, the tips 1 are detached in order from all of the syringes 20 arranged in the D1 direction by the above-mentioned operation of detaching a tip 1. Thus, as compared to a case in which all of the tips 1 are detached at the same time, it is possible to detach all of the tips 1 with a small force. Further, after the tips 1 are detached, the mobile plates 33, 34 are moved upwardly by rotation of the rotation shaft of the actuator 51 in the reverse direction. Further, the detachment frame 10 is moved upwardly by the plurality of spring members (not shown). Thus, the dispensing device 100 returns to the normal state.

Further, in the present embodiment, it is possible to end the operation of detaching a tip 1 at point in time at which the tips 1E, 1K are detached from the syringes 20E, 20K, respectively. In this case, the tips 1A, 1C, 1E, 1G, 1I, 1K are detached from the six syringes 20A, 20C, 20E, 20G, 20I, 20K, respectively. On the other hand, the tips 1B, 1D, 1F, 1H, 1J, 1L attached to the six syringes 20B, 20D, 20F, 20H, 20J, 20L remain. The six syringes 20 from which the tips 1 are removed are not used for an operation of sucking a sample or an operation of discharging a sample.

In the above-mentioned state, dispensing is performed with use of the respective six syringes 20, which have the remaining tips 1 and are arranged at equal intervals, at six respective dispensing positions such as the positions of 6 test tubes, 6 sample bottles, 6 wells or the like. That is, it is possible to perform dispensing at the number of dispensing positions that is smaller than the number of syringes 20. For example, it is possible to perform dispensing with respect to wells aligned in 3 rows and 6 columns by relatively and discretely moving six syringes 20 arranged in the D1 direction three times in the D2 direction. Also in this case, after the use of the tips 1, the tips 1B, 1D, 1F, 1H, 1J, 1L are detached from the syringes 20B, 20D, 20F, 20H, 20J, 20L, respectively, by an operation of detaching a tip 1.

After the tip 1 is detached from each syringe 20, a new tip 1 is attached to each syringe 20. In an operation of attaching a tip 1, a rack for accommodating a plurality of new tips 1 for replacement is prepared. In the rack, 96 tips 1 are aligned in 8 rows and 12 columns, for example. The syringe 20 is moved downwardly by an actuator (not shown) with the rack arranged below the plurality of syringes 20, whereby the plurality of tips 1 accommodated in the rack are attached to the lower end portions of the nozzles 23 of the plurality of syringes 20, respectively.

### (4) Modified Examples

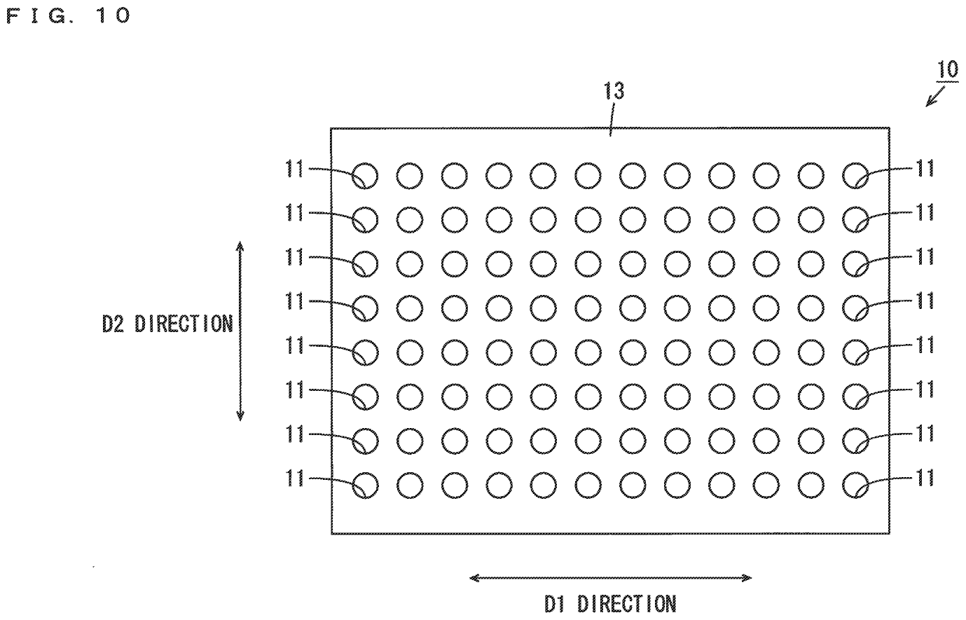

While the plurality (eight in the present example) of through holes 11 extending in the D1 direction are formed in the detachment frame 10 in the present embodiment, the embodiment is not limited to this. FIG. 10 is a plan view showing the configuration of a detachment frame 10 according to a first modified example. As shown in FIG. 10, a plurality of through holes 11 aligned in the D1 direction and the D2 direction may be formed in the detachment frame 10. In the example of FIG. 10, 96 circular through holes 11 aligned in 8 rows and 12 columns are formed in the detachment frame 10. The plurality of through holes 11 correspond to a plurality of syringes 20, respectively.

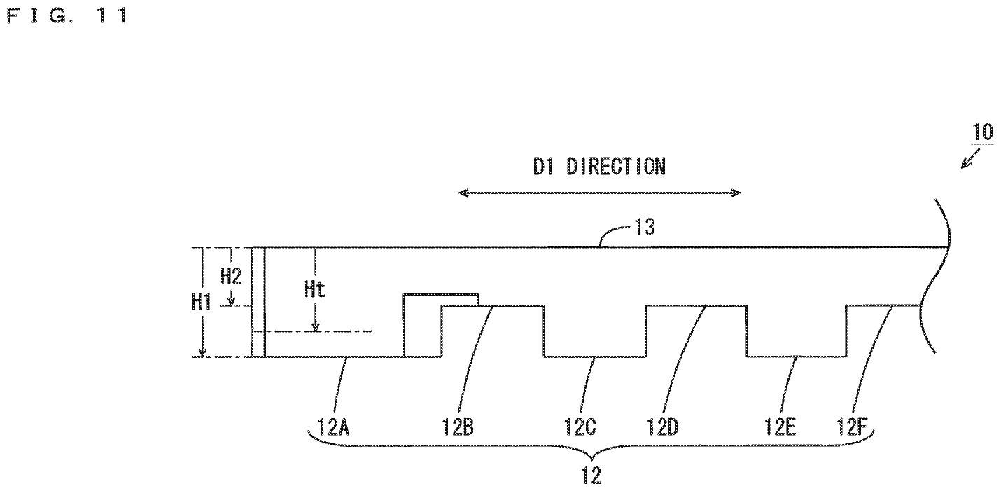

While the height positions of regions 12A to 12F of the detachment frame 10 are different from one another and the height positions of regions 12G to 12L of the detachment frame 10 are different from one another in the present embodiment, the embodiment is not limited to this. FIG. 11 is a partially enlarged view of a detachment frame 10 according to a second modified example. As shown in FIG. 11, in the detachment frame 10 according to the present example, regions 12A, 12C, 12E, 12G, 12I, 12K are located at the same height position, and regions 12B, 12D, 12F, 12H, 12J, 12L are located at the same height position.

In the example of FIG. 11, the regions 12A, 12C, 12E are located at a height position H1, and the regions 12B, 12D, 12F are located at a height position H2 that is higher than the height position H1. The height positions of the regions 12G to 12L are equal to the height positions of regions 12A to 12F, respectively. A height threshold value Ht is defined between the height position H1 and the height position H2.

### (5) Effects

In the dispensing device 100 according to the present embodiment, the detachment frame 10 is lowered with respect to the plurality of syringes 20, so that a tip 1 attached to the lower end portion of each of a plurality of syringes 20 is detached. On the other hand, when the detachment frame 10 is lowered by a predetermined distance with respect to the plurality of syringes 20, the tips 1 attached to the lower end portions of some of the syringes 20 are detached.

The tips 1 attached to the lower end portions of the other syringes 20 remain without being detached. Further, the syringes 20 having the remaining tips 1 are regularly aligned. Therefore, it is possible to perform dispensing at the number of dispensing positions that is smaller than the number of syringes 20 provided in the dispensing device 100 by using the syringes 20 having the remaining tips 1. This improves usability of the dispensing device 100.

Further, in the present embodiment, driving of the syringes 20 and detachment of the tips 1 are performed by a common actuator 51. Thus, the dispensing device 100 can be miniaturized. Further, the cost of the dispensing device 100 can be reduced.

Further, in the present embodiment, the regions 12A to 12F of the lower surface 12 of the detachment frame 10 are at height positions different from one another, and the regions 12G to 12L are at height positions different from one another. In this case, because the tips 1 are detached from the plurality of syringes 20 in stages, it is not necessary to apply a large force to the detachment frame 10 when detaching a tip 1 from each syringe 20. Therefore, the detachment frame 10 can be driven by a smaller actuator 51. Thus, it is possible to reduce the size of the dispensing device 100 and reduce the cost of the detachment frame 10.

### (6) Other Embodiments

(a) While the plurality of through holes 11 are provided in the detachment frame 10 to be arranged in the D2 direction in the above-mentioned embodiment, the embodiment is not limited to this. One through hole 11 extending in the D1 direction may be formed in the detachment frame 10. Alternatively, a plurality (twelve, for example) of through holes 11 aligned in the D1 direction may be formed in the detachment frame 10.

(b) While each rod 40 is provided so as to extend upwardly from the detachment frame 10 in the above-mentioned embodiment, the embodiment is not limited to this. Each rod 40 may be provided to extend downwardly from the mobile plate 34. In this case, in a normal state, the lower end portion of each rod 40 and the upper surface 13 of the detachment frame 10 are spaced apart from each other by a predetermined distance.

(c) While driving of the syringes 20 and detachment of the tips 1 are performed by the common actuator 51 in the above-mentioned embodiment, the embodiment is not limited to this. The driving of the syringes 20 and the detachment of the tips 1 may be performed by a separate actuator. In this case, a rod 40 does not have to be provided in the dispensing device 100, and the detachment frame 10 does not have to be biased upwardly.

(d) While the dispensing device 100 includes the actuator 51 that moves the detachment frame 10 downwardly in the above-mentioned embodiment, the embodiment is not limited to this. In a case in which the detachment frame 10 is moved manually and downwardly, the dispensing device 100 does not have to include the actuator 51.

(e) While the detachment frame 10 is moved downwardly with respect to the plurality of syringes 20 in the above-mentioned embodiment, the embodiment is not limited to this. The detachment frame 10 may be moved downwardly relative to the plurality of syringes 20. Thus, the plurality of syringes 20 may be moved upwardly with respect to the detachment frame 10.

(f) While the 96 syringes 20 are aligned in 8 rows and 12 columns in the above-mentioned embodiment, the embodiment is not limited to this. As long as a plurality of syringes 20 are present, any number of syringes 20 may be aligned in any manner. Further, the number and arrangement of the through holes 11 provided in the detachment frame 10 and the number and arrangement of the regions of the lower surface 12 of the detachment frame 10 may be changed in accordance with the alignment of the syringes 20.

### (7) Aspects

It is understood by those skilled in the art that the plurality of above-mentioned illustrative embodiments are specific examples of the below-mentioned aspects.

(Item 1) A dispensing device according to one aspect includes a plurality of syringes being aligned in a first direction that intersects with a vertical direction while being directed downwardly, a detachment frame that has a plate shape having a through hole into which the plurality of syringes are inserted and is provided to be liftable and lowerable relative to the plurality of syringes, and a tip attachment region in which a tip is attachable to a lower end portion of each of the plurality of syringes that project farther downwardly than the detachment frame through the through hole, wherein the detachment frame has a first region located at a position lower than a predetermined height threshold value defined with respect to the detachment frame and a second region located at a position higher than the height threshold value in a lower surface, and the first region and the second region are arranged alternately in the first direction.

In the dispensing device, when the detachment frame is lowered sufficiently relative to the plurality of syringes, the tip attached to the lower end portion of each of the plurality of syringes is detached. On the other hand, when the detachment frame is lowered by a predetermined distance relative to the plurality of syringes, the tips attached to the lower end portions of some of the syringes are detached.

The tips attached to the lower end portions of the other syringes remain without being detached. Also, the syringes having the remaining tips are regularly aligned. Therefore, it is possible to perform dispensing at the number of dispensing positions that is smaller than the number of syringes provided in the dispensing device by using the syringes having the remaining tips. This improves usability of the dispensing device.

Further, the tips are detached from the plurality of syringes in stages. Therefore, when detaching a tip from each syringe, it is not necessary to apply a large force to the detachment frame. Thus, the tips can be detached from the syringe more reliably.

(Item 2) The dispensing device according to item 1, may further include an actuator that moves the detachment frame downwardly relative to the plurality of syringes.

In this case, it is possible to easily detach the tips from the syringes by driving the actuator.

(Item 3) The dispensing device according to item 2, wherein each of the plurality of syringes may include a plunger, and the actuator may further lift or lower the plunger relative to a corresponding syringe.

In this case, driving of the syringes and detachment of the tips are performed by the common actuator. Thus, the dispensing device can be miniaturized. Further, the cost of the dispensing device can be reduced.

(Item 4) The dispensing device according to item 3, wherein the detachment frame may be biased upwardly relative to the plurality of syringes.

In this case, with a simple configuration, driving of the syringes and detachment of the tips can be performed by the common actuator.

(Item 5) The dispensing device according to any one of items 1 to 4, wherein the detachment frame may have the first region and the second region a total number of which is equal to or larger than 3, the first region and the second region being arranged in the first direction in the lower surface and being located at different height positions.

In this case, the tips are detached from the plurality of syringes in more stages. Thus, the tips can be detached from the syringes more easily.

(Item 6) The dispensing device according to any one of items 1 to 4, wherein the plurality of syringes may be aligned in the first direction and a second direction that intersects with the vertical direction and the first direction, and the detachment frame may have a plurality of the through holes arranged in the second direction.

With this configuration, even in a case in which the plurality of syringes are aligned in the first direction and the second direction, the tips attached to the lower end portions of some or all of the syringes can be detached. Further, it is possible to perform dispensing at the number of dispensing positions that is smaller than the number of syringes provided in the dispensing device by detaching the tips attached to the lower end portions of some of the syringes.

(Item 7) A detachment frame according to another aspect that is used in a dispensing device including a plurality of syringes that are aligned in a first direction intersecting with a vertical direction while being directed downwardly, wherein a detachment frame has a plate shape having a through hole into which the plurality of syringes are inserted, and a tip attachment region in which a tip is attachable to a lower end portion of each of the plurality of syringes that project farther downwardly than the detachment frame through the through hole, and the detachment frame has a first region located at a position lower than a predetermined height threshold value defined with respect to the detachment frame and a second region located at a position higher than the height threshold value in a lower surface, and the first region and the second region are arranged alternately in the first direction.

When the detachment frame is lowered, the tips attached to the lower end portions of some or all of the syringes can be detached. Further, it is possible to perform dispensing at the number of dispensing positions that is smaller than the number of syringes provided in the dispensing device by detaching the tips attached to the lower end portions of some of the syringes. This improves usability of the dispensing device.

Further, the tips are detached from the plurality of syringes in stages. Therefore, when detaching a tip from each syringe, it is not necessary to apply a large force to the detachment frame. Thus, the tips can be detached from the syringes more reliably.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/we claim:

1. A dispensing device comprising:
a plurality of syringes being aligned in a first direction that intersects with a vertical direction while being directed downwardly;
a detachment frame that has a plate shape having a through hole into which the plurality of syringes are inserted and is provided to be liftable and lowerable relative to the plurality of syringes; and
a tip attachment region in which a tip is attachable to a lower end portion of each of the plurality of syringes that project farther downwardly than the detachment frame through the through hole, wherein
the detachment frame has a first region located at a position lower than a predetermined height threshold value defined with respect to the detachment frame and a second region located at a position higher than the height threshold value in a lower surface, and the first region and the second region are arranged alternately in the first direction.

2. The dispensing device according to claim 1, further comprising an actuator that moves the detachment frame downwardly relative to the plurality of syringes.

3. The dispensing device according to claim 2, wherein
each of the plurality of syringes includes a plunger, and
the actuator further lifts or lowers the plunger relative to a corresponding syringe.

4. The dispensing device according to claim 3, wherein
the detachment frame is biased upwardly relative to the plurality of syringes.

5. The dispensing device according to claim 1, wherein
the detachment frame has the first region and the second region a total number of which is equal to or larger than 3, the first region and the second region being arranged in the first direction in the lower surface and being located at different height positions.

6. The dispensing device according to claim 1, wherein
the plurality of syringes are aligned in the first direction and a second direction that intersects with the vertical direction and the first direction, and
the detachment frame has a plurality of the through holes arranged in the second direction.

7. A detachment frame that is used in a dispensing device including a plurality of syringes that are aligned in a first direction intersecting with a vertical direction while being directed downwardly, wherein
a detachment frame has a plate shape having a through hole into which the plurality of syringes are inserted, and
a tip attachment region in which a tip is attachable to a lower end portion of each of the plurality of syringes that project farther downwardly than the detachment frame through the through hole, and
the detachment frame has a first region located at a position lower than a predetermined height threshold value defined with respect to the detachment frame and a second region located at a position higher than the height threshold value in a lower surface, and the first region and the second region are arranged alternately in the first direction.
